(19) United States
(12) Patent Application Publication
(10) Pub. No.: US 2012/0045386 A1
(43) Pub. Date: Feb. 23, 2012

(54) URANIUM CATALYST ON A SUBSTRATE HAVING A SPECIFIC PORE SIZE DISTRIBUTION, METHOD FOR THE PRODUCTION THEREOF AND USE THEREOF

(75) Inventors: Aurel Wolf, Wulfrath (DE); Leslaw Mleczko, Dormagen (DE); Oliver Felix-Karl Schlüter, Leverkusen (DE); Stephan Schubert, League City, TX (US)

(73) Assignee: BAYER TECHNOLOGY SERVICES GMBH, Leverkusen (DE)

(21) Appl. No.: 13/257,171

(22) PCT Filed: Mar. 9, 2010
(86) PCT No.: PCT/EP2010/001443

§ 371 Date: Oct. 31, 2011

(30) Foreign Application Priority Data
Mar. 19, 2009 (DE) 10 2009 013 905.2

(51) Int. Cl. C01B 7/04; B01J 21/02

(52) U.S. Cl. 423/502; 502/355; 502/344; 502/341

(57) ABSTRACT

The present invention relates to a novel uranium catalyst on a support of particular pore size distribution, to a process for preparation thereof, and to the use thereof in the course of processes for preparing chlorine from hydrogen chloride.

The present invention relates to a novel uranium catalyst on a support of particular pore size distribution, to a process for preparation thereof, and to the use thereof in the course of processes for preparing chlorine from hydrogen chloride.

Virtually all of the industrial production of chlorine is accomplished nowadays by electrolysis of aqueous sodium chloride solutions.

However, a significant disadvantage of such chloralkali electrolysis processes is that not only the desired chlorine reaction product but also sodium hydroxide solution is obtained in a large amount. Thus, the amount of sodium hydroxide solution produced is coupled directly to the amount of chlorine produced. However, the demand for sodium hydroxide solution is not coupled to the demand for chlorine, and so, especially in the recent past, the sales revenues for this by-product have declined significantly.

In process technology terms, this means that, in such chloralkali electrolysis processes, energy is present bound within a product, but there is not a sufficient degree of compensation for the expenditure of this energy.

An alternative to such processes is offered by the “Deacon process”, developed as early as 1868 by Deacon and named after him, in which chlorine is formed by heterogeneously catalytic oxidation of hydrogen chloride with simultaneous formation of water. The significant advantage of this process is that it is decoupled from the preparation of sodium hydroxide solution. Furthermore, the hydrogen chloride precursor is simple to obtain; it is obtained in large amounts, for example, in phosgenation reactions, for instance in isocyanate preparation, in which the chlorine produced is again preferably used via the phosgene intermediate.

According to the prior art, preference is given to using catalysts comprising transition metals and/or noble metals for the conversion of hydrogen chloride to chlorine.

For instance, WO 2007 134771 discloses that catalysts comprising at least one of the elements copper, potassium, sodium, chromium, cerium, gold, bismuth, ruthenium, rhodium, platinum and the elements of transition group VIII of the Periodic Table of the Elements can be used for this purpose. It is further disclosed that the oxides, halides or mixed oxides/halides of the aforementioned elements are used with preference. Especially preferred are copper chloride, copper oxide, potassium chloride, sodium chloride, chromium oxide, bismuth oxide, ruthenium oxide, ruthenium chloride, ruthenium oxychloride and rhodium oxide.

According to the disclosure of WO 2007 134771, these catalysts are notable for a particularly high activity for the conversion of hydrogen chloride to chlorine.

WO 2004 052776 discloses that a commonly known problem in the field of the heterogeneously catalytic oxidation of hydrogen chloride to chlorine is that so-called “hotspots” form in the processes. These “hotspots” refer to sites of greater-than-proportional temperature increase, which, according to the disclosure of WO 2004 052776, can lead to the destruction of the catalyst material. WO 2004 052776 discloses, as an approach to a solution to this technical problem, the performance of a cooled process in tube bundles.

The technical solution disclosed in WO 2004 052776 comprises the cooling of the catalyst tubes. The alternative technical solution disclosed in WO 2007 134771 comprises the multistage adiabatic performance of the process with cooling between the stages.

Both technical solutions are complicated in process technology and apparatus terms and are therefore disadvantageous at least economically, since the capital costs for the apparatus are considerable in each case either owing to a complicated embodiment in the case of WO 2004 052776 or owing to a multiple execution of a simpler embodiment in the case of WO 2007 134771. In addition, in both cases, there is the technically disadvantageous effect that, using the catalysts disclosed there, destruction thereof cannot be ruled out in the event of a fault.

Moreover, neither of the aforementioned publications discloses any properties of the catalyst with regard to pore size distribution.

A further alternative to the solution to the abovementioned problems which is complicated in apparatus terms, in relation to the catalysts, is disclosed by EP 1 170 250. According to the disclosure of EP 1 170 250, the excessively high temperatures in the region of the reaction zones are counteracted by using catalyst beds adjusted to the reaction profile with reduced activity of the catalyst. Such adjusted catalyst beds are achieved, for example, by “diluting” the catalyst beds with inert material, or by simply creating reaction zones with a lower proportion of catalyst.

The process disclosed in EP 1 170 250 is, however, disadvantageous since such a “dilution” creates reaction zones with a desirably low space-time yield. However, this is at the expense of the economically viable operation of the process, since the reaction zones, which are highly diluted with inert material especially at the start of the process, first have to be heated to the operating temperatures. Energy is expended for this purpose, in order to heat the inert material which is actually not required for performance of the reaction. According to the disclosure of EP 1 170 250, destruction of the catalysts in the case of a fault can not least not be ruled out either.

EP 1 170 250 also does not disclose any properties of the catalyst material with regard to its pore size distribution.

DE 1 078 100 discloses that catalysts comprising uranium are also usable for the heterogeneously catalytic oxidation of hydrogen chloride to chlorine. DE 1 078 100 further discloses that such catalysts are also usable at higher temperatures up to 480° C. without risk of destruction. The catalysts disclosed in DE 1 078 100 comprise support materials such as kaolin, silica gel, kieselguhr, pumice and others. In DE 1 078 100, the catalysts are prepared by applying the uranium from the solution to the support. It is not disclosed that the catalysts can be obtained by precipitation. Moreover, the catalysts disclosed do not comprise any uranates comprising sodium and uranium.

The maximum achievable conversion which can be achieved in DE 1 078 100 with the catalysts is 62%, which is low and hence disadvantageous measured by the conversions possible according to the disclosures detailed above. This is especially true since, in the specific working example in which said 62% conversion is achieved, 600 cm³ of the reactor are filled with the catalyst. This in turn means that the activity of the catalyst, given the further information, appears to be quite low.

DE 1 078 100 also does not disclose any properties of the catalyst material or of the kaolin, silica gel, kieselguhr or pumice support material used with regard to pore size distribution.

The patent specification with the international application number PCT/EP2008/005183 discloses uranium oxide catalysts which, in a preferred development, consist only of uranium oxide, or which, in the general case, consist of a support composed of uranium oxide and a further catalytic component.

It is further disclosed that examples of suitable support materials combinable with the uranium oxide are silicon dioxide, titanium dioxide with rutile or anatase structure, zirconium dioxide, aluminium oxide or mixtures thereof.

The aforementioned further catalytically active components according to PCT/EP2008/005183 may, for instance, be the substances already disclosed in WO 2007 134771.

The catalysts comprising the support composed of uranium oxide and a further catalytically active component can, according to PCT/EP2008/005183, be obtained by impregnating the further catalytically active component onto the support composed of uranium oxide.

The catalysts disclosed in PCT/EP2008/005183 are disclosed as particularly stable, such that they are advantageous over the catalysts which are used according to the disclosures of WO 2004 052776, WO 2007 134771 and EP 1 170 250. The catalysts have quite high productivities at temperatures of 540° C. and 600° C. according to the working examples of PCT/EP2008/005183. However, these still remain inferior to the possible productivities as would be achievable, for instance, with other catalysts according to the disclosures of WO 2004 052776, WO 2007 134771 and EP 1 170 250 at lower temperatures. Thus, a certain activity of the catalysts for the heterogeneously catalytic oxidation of hydrogen chloride to chlorine has been dispensed with in favour of stability, which is disadvantageous.

PCT/EP2008/005183 also does not disclose that the catalysts have a particular pore size distribution.

A further improvement in the activity of catalyst materials similar to those of PCT/EP2008/005183 is disclosed in German application DE 10 2008 050978.7.

According to the disclosure of DE 10 2008 050978.7, this improvement is achieved through the surprising finding that uranates, as an embodiment of uranium compounds as disclosed in general terms according to PCT/EP2008/005183, result in an enhancement in the activity for heterogeneously catalytic oxidation of hydrogen chloride with oxygen to give chlorine.

DE 10 2008 050978.7 also does not disclose what pore size distribution the catalysts disclosed have, or that this may influence the activity of the catalyst. Even if the catalysts according to DE 10 2008 050978.7 have an activity enhanced relative to PCT/EP2008/005183 for heterogeneously catalytic oxidation of hydrogen chloride with oxygen to give chlorine, these activities are still inferior to those, for instance, of the catalysts according to WO 2004 052776, WO 2007 134771 and EP 1 170 250, which, however, as already described, have the disadvantage of low thermal stability.

Proceeding from the prior art, there is thus still the need to provide a catalyst for heterogeneously catalytic oxidation of hydrogen chloride with oxygen to give chlorine, which can be used in a higher temperature range without the risk of lasting damage, and which has an increased activity compared to the other catalysts usable in these temperature ranges.

It has now been found that, surprisingly, this object is achieved by a catalyst for heterogeneously catalytic oxidation of hydrogen chloride to chlorine, comprising at least one catalytically active component composed of a uranium compound and a support material composed of aluminium oxide, characterized in that the catalyst has a bimodal pore size distribution.

The uranium compounds usable in connection with the present invention are those as already disclosed in connection with PCT/EP2008/005183 or DE 10 2008 050978.7 as possible uranium compounds.

Accordingly, the uranium compound according to the present invention may be a uranium oxide. Such uranium oxides are, for instance, UO₃, UO₂, UO or the nonstoichiometric phases resulting from mixtures of these species, for example, U₃O₅, U₂O₅, U₃O₇, U₃O₈, U₄O₉, U₁₃O₃₄. Preferred uranium oxides are those with a stoichiometric composition of UO_{2.1} to UO_{2.9}.

Moreover, the uranium compound according to the present invention may be a uranate. Such uranates are substances comprising uranium and oxygen in any stoichiometric or nonstoichiometric composition which have negative charges.

Uranates are preferably negatively charged substances with a composition of UO_{X} where X is a real number greater than 1 but less than or equal to 5.

The uranates of the present invention typically contain at least one alkali metal and/or alkaline earth metal. Alkali metal and/or alkaline earth metal refer in the context of the present invention to any substance from the first or second main group of the Periodic Table of the Elements.

Preferred alkali metals and/or alkaline earth metals are those selected from the list comprising barium, calcium, cesium, potassium, lithium, magnesium, sodium, rubidium and strontium.

Particular preference is given to those selected from the list comprising barium, calcium, potassium, magnesium and sodium.

The uranates of the at least one alkali metal and/or alkaline earth metal typically have a general composition [M^{q}]_{2m/q}[UₙO₃ₙ₊ₘ] where n=1, 2, 3, 6, 7, 13, 16 and m=1, 2 or 3 and q=1 or 2. q here represents the number of positive charges that the alkali metal or alkaline earth metal has.

Preferred uranates of alkali metals or alkaline earth metals are Na₆U₇O₂₄ or Ba₃U₇O₂₄.

Particular preference is given to the sodium uranate Na₆U₇O₂₄.

The aforementioned uranates have just as high a stability as those already disclosed in PCT/EP2008/005183, but simultaneously exhibit a drastically enhanced activity for the heterogeneously catalytic oxidation of hydrogen chloride with oxygen to give chlorine.

In a preferred embodiment, the catalyst disclosed here also comprises uranium oxide in addition to the uranate.

In other alternative embodiments, the catalyst comprises, in addition to the uranate of at least one alkali metal and/or alkaline earth metal, also salts and/or oxides of alkali metals and/or alkaline earth metals.

The inventive catalyst is especially advantageous over the prior art since it has the aforementioned bimodal pore size distribution.

In connection with the present invention, a bimodal pore size distribution means the fact that the inventive catalyst, on analysis by means of mercury porosimetry as is commonly known to the person skilled in the art, has a first pore volume associated with pore sizes of a mean pore diameter in a first range and a second pore volume associated with pore sizes of a mean diameter in a second range, the two aforementioned ranges of pore size, moreover, not overlapping with one another.

The result of the aforementioned bimodal pore size distribution is that the pores in the range of the greater diameter enable improvement of the distribution in the catalyst, which leads to more rapid transport of the reactants to the heterogeneously catalytic sites of the catalyst and to more rapid transport of the reaction products away from the heterogeneously catalytic sites of the catalyst. Moreover, the pores in the range of the smaller diameter lead to a simultaneous increase in the specific surface area of the catalyst, which leads to a higher conversion rate per unit catalyst volume used or per unit catalyst mass used.

The combination of the pore sizes of the two aforementioned ranges in the manner of a bimodal distribution leads to the effect that a high specific surface area of the catalyst is available rapidly for the reaction of individual reactants over the heterogeneously catalytic sites of the catalyst or is available again rapidly after reaction, such that a particularly high activity of the inventive catalyst is the overall result.

The inventive catalyst thus has at least two ranges of pore sizes: a first range for smaller diameters and a second for greater diameters.

The aforementioned ranges of the pore sizes are typically in the range from 1 to 20 nm for the range of smaller diameter and 100 to 5000 nm for the range of greater diameter. In preferred embodiments of the inventive catalyst in the range from 3 to 15 nm for the range of smaller diameter and 150 to 2500 nm for the range of greater diameter.

Since the ranges of the diameters associated with the two aforementioned proportions of the pore volumes do not overlap in accordance with the invention, it is also possible that the ranges directly adjoin one another. If, in other words, according to possible individual embodiments of a bimodal pore size distribution according to the present invention, the diameter ranges could intersect with one another, this means that, proceeding from the range of the diameter of the pore volumes with a smaller diameter, the diameter range of the pore volumes with a greater diameter directly adjoins it.

In such cases, the sum of the proportions of the pore volumes of the two aforementioned ranges may be 100%.

Typically, the proportion of the pore volumes in the range of the smaller diameter is from 40% to 60%, preferably about 50%. At the same time, the proportion of the pore volumes in the range of the greater diameter is likewise from 60% to 40%, preferably about 50%, where the sum of the proportions may be less than or equal to 100%.

Especially the combination of the proportion of pore volumes of the range of smaller diameter with the proportion of pore volumes of the range of greater diameter in conjunction with the above-disclosed mean diameters according to the individual preferred embodiments leads to a particularly advantageous extent of the simplified transport of the substances to/away from the heterogeneously catalytic sites of the catalyst together with the particularly high specific surface area of the catalyst, such that inventive catalysts of this type have superior activity to the catalysts known from the prior art and simultaneously have, as a result of the uranium compound used on an aluminium oxide support, a particularly high stability with regard to temperature and further process parameters in which they are used.

The catalyst disclosed according to this invention may be present in all geometric embodiments which appear viable for later use in connection with processes for heterogeneously catalytic oxidation of hydrogen chloride with oxygen to give chlorine.

In preferred embodiments of the present invention, the inventive catalyst is present in the form of a particle bed or in the form of a shaped body.

When the catalyst, according to the preferred embodiment of the present invention, is present in the form of a particle bed, the mean diameter of the particles of the particle bed is typically from 0.5 to 8 mm, preferably from 1 to 5 mm.

The upper limits of the aforementioned ranges are particularly advantageous because, above the mean diameter disclosed, the particular advantage of the inventive catalyst is reduced, in spite of the improved transport of the substances to/away from the heterogeneously catalytic sites of the catalyst, by virtue of the mean distance to the proportion of the inventive catalyst with particularly high specific surface area being extended such that a significant proportion of the reactants already reacts in the region of the pore volumes associated with a range of greater diameter, which is inefficient.

The lower limits of the aforementioned ranges are particularly advantageous because, below the mean diameter disclosed, the particular advantage of the inventive catalyst is reduced by virtue of improved transport of the substances to/away from the heterogeneously catalytic sites of the catalyst becoming dispensible here because a large proportion of the catalyst is in any case directly in contact with the reactants. This would likewise be inefficient.

When the catalyst, in the preferred embodiment of the present invention, is present in the form of a shaped body, the shaped body is porous and is configured such that it is identifiable as an agglomerate of aforementioned particles of the particle bed.

In the context of the present invention, this means that the inventive shaped bodies, as a manifestation of the inventive catalyst, are characterized by interfaces between particles of the inventive catalyst bonded to one another.

The embodiment as porous shaped bodies with interfaces between particles of the inventive catalyst bonded to one another is advantageous because more readily manageable manifestations of the inventive catalyst are thus obtained, which, however, still have the advantageous properties of the aforementioned particles of the particle beds in the advantageous size ranges disclosed.

The proportion of the uranium compound in the overall inventive catalyst, regardless of its geometric manifestation, is typically in the range from 1 to 40% by weight, preferably in the range from 3 to 25% by weight.

The present invention further provides a process for preparing the inventive catalysts, characterized in that it comprises at least the steps of
a) providing a solution A comprising a uranium salt in a solvent,
b) coating particles of aluminium oxide with solution A to obtain coated particles B,
c) drying the coated particles B, and
d) optionally shaping shaped bodies from the coated particles B obtained from one of steps b) and c).

The uranium salt of solution A in step a) of the process according to the invention refers, in the context of the present invention, to any compound comprising at least one ion of the element uranium with at least one counterion, the entirety of the one or more counterions bearing a total of as many opposite charges as the entirety of the one or more uranium ions present.

The uranium ions in the inventive uranium salt may have a double, triple, quadruple, quintuple or sextuple positive charge. The uranium ions in the uranium salt are preferably quadruply, quintuply or sextuply positively charged. The uranium ions of the uranium salt are more preferably sextuply positively charged.

Preferred uranium salts are those selected from the list consisting of uranyl acetate UO₂Ac₂, uranyl acetate dihydrate UO₂Ac₂.2H₂O, uranyl oxide nitrate UO₂(NO₃)₂ and uranyl oxide nitrate hexahydrate UO₂(NO₃)₂.6H₂O.

The solvent of solution A in step a) of the process according to the invention refers, in the context of the present invention, to a solvent selected from the group consisting of water, mono- or polyhydric alcohol having not more than five carbon atoms and benzene. Preference is given to water.

The aforementioned preferred uranium salts are particularly advantageous in conjunction with the preferred solvent of water because they can be dissolved in high proportions in aqueous solutions, and the acetate and nitrate radicals are simultaneously typically present in completely dissociated form in water. Moreover, these uranium salts are particularly advantageous because they can be converted in the course of drying in step c) at the preferred temperatures to gaseous nitrogen oxides or gaseous carbon oxides such as carbon monoxide or carbon dioxide, and therefore can no longer contaminate the catalyst obtained.

The solution A present in the process in step a) refers to solutions in which all substances are present in molecularly dissolved form.

The coating in step b) of the process according to the invention can be accomplished by precipitating the uranium salt out of solution A in the presence of the particles of aluminium oxide or by immersing the particles of aluminium oxide into solution A or by spraying the particles of aluminium oxide with solution A. Preference is given to coating by spraying the particles of aluminium oxide with the solution A.

The drying in step c) of the process according to the invention can be effected under atmospheric pressure (1013 hPa) or reduced pressure relative to atmospheric pressure, preference being given to performing the drying at atmospheric pressure.

At the same time, the drying can be effected at room temperature (23° C.) or at elevated temperature relative to room temperature, preference being given to performing the drying at elevated temperature relative to room temperature.

Particular preference is given to performing the drying at temperatures of 500° C. to 1500° C.

In alternative embodiments of step c) of the process according to the invention, the drying can also be performed in more than one stage. In such alternative embodiments, preference is given to providing preliminary drying at room temperature to 250° C. and subsequent drying at temperatures of 500° C. to 1500° C.

Such temperatures of 500° C. to 1500° C. are particularly advantageous because, as a result, all hydroxides and/or hydrates of uranium present after the coating on the surface of the coated particles B are thus converted to oxides and/or salts and hence the preferred uranates and/or uranium oxides are formed.

The inventive drying or the subsequent drying in the alternative embodiment of the process according to the invention at 500° C. to 1500° C. can in this respect also be combined under the term “calcination” which is common knowledge to the person skilled in the art.

The shaping of shaped bodies in step d) from the coated particles B can be effected using the particles B from step b) or step c).

When shaped bodies are shaped from the coated particles B from step c) of the process according to the invention, this is typically done by adding a binder and subsequently drying, in the course of which drying step, the particles B are pressed into a negative mould of the desired shaped body.

The aforementioned binder is typically one of the solvents of solution A in step a) of the process according to the invention or a gel of aluminium oxide (Al₂O₃) or silicon dioxide (Sif₂) in water. The binder is preferably water.

The drying is effected typically at the temperatures as disclosed for the drying in step c) of the process according to the invention for preliminary drying, though the pressure under which this drying is performed is elevated relative to atmospheric pressure and this pressure is obtained by compressing the aforementioned negative mould around the particles B with which the negative mould has been filled.

When shaped bodies are shaped from the coated particles B from step b) of the process according to the invention, this is typically done by drying at the temperatures as disclosed for the drying in step c) of the process according to the invention for preliminary drying, though the pressure under which this drying is performed is elevated relative to atmospheric pressure and this pressure is obtained by compressing the aforementioned negative mould around the particles B with which the negative mould has been filled.

The present invention further provides processes for preparing chlorine, characterized in that hydrogen chloride is oxidized with oxygen to chlorine in a reaction zone in the presence of a catalyst with bimodal pore size distribution comprising at least one catalytically active component composed of a uranium compound and a support material composed of aluminium oxide.

Such processes are preferably operated at temperatures above 400° C. in one reaction zone.

It is common knowledge to the person skilled in the art that the reaction rate of a chemical reaction generally rises with the temperature at which it is performed. The processes according to the invention disclosed here for oxidation of hydrogen chloride to chlorine are thus particularly advantageous because, for the first time, the increased reaction rates for the industrial production of chlorine from hydrogen chloride can thus be achieved without the catalysts being destroyed as a result. At the same time, the bimodal pore size distribution enables maximum exploitation of the catalyst material in the sense of an activity per unit catalyst mass used and/or per unit catalyst volume.

The present invention therefore further provides for the use of the above-disclosed embodiments of the inventive and preferred catalysts for the oxidation of hydrogen chloride to chlorine.

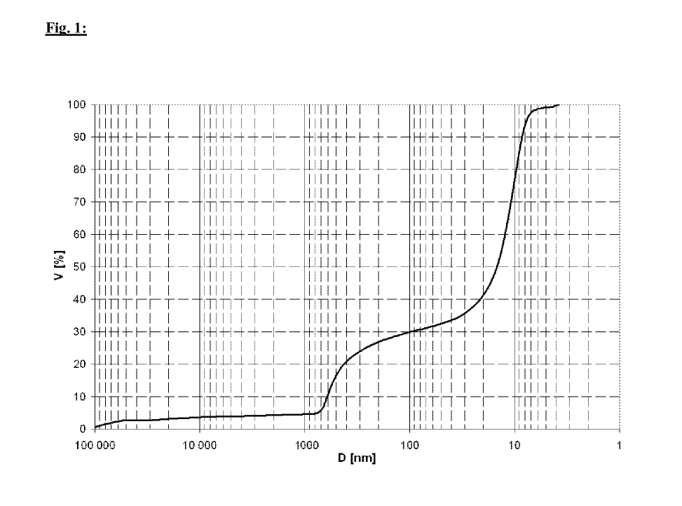

FIG. 1 shows the inventive bimodal pore size distribution of the spherical gamma-Al₂O₃ shaped bodies according to Example 1. The proportion of the pore volumes (V) is shown against the particular pore diameter (D) in nanometers [nm]. The turning points are clearly evident, and hence significant pore fractions of the pore diameter distribution at D˜500 nm, and D˜10 nm.

The invention is illustrated in detail hereinafter with reference to examples, but without thereby restricting it thereto.

### EXAMPLES

### Example 1

### Preparation of an Inventive Catalyst

In a beaker, 5 g of spherical gamma-Al₂O₃ shaped bodies (purchased from Saint-Gobain) of average diameter 1.5 mm, BET surface area 249 m²/g, mean pore diameter d_{P} of ˜10/1000 nm and pore volume V_{Hg,P} 1.35 cm³/g were impregnated with a 10% by weight aqueous solution of uranyl acetate dihydrate (from Riedel de Haen) by spraying.

After a contact time of 1 h, the solid was dried in an air stream at 80° C. for 2 h. The entire experiment was repeated until 5% by weight of uranium was calculated to be present on the shaped bodies. The completely laden catalyst is then calcined under air at 800° C. for 4 h.

### Example 2

### Preparation of an Inventive Catalyst

A catalyst according to Example 1 was prepared, except that the impregnation/drying step was repeated until a catalyst with a calculated uranium loading of 10% by weight was obtained.

### Example 3

### Preparation of an Inventive Catalyst

A catalyst according to Example 1 was prepared, except that the impregnation/drying step was repeated until a catalyst with a calculated uranium loading of 15% by weight was obtained.

### Example 4

### Preparation of an Inventive Catalyst

A catalyst according to Example 1 was prepared, except that 5 g of spherical gamma-Al₂O₃ shaped bodies (produced by Saint-Gobain) with an average diameter of 1.5 mm, a BET of 250 m²/g, a mean pore diameter d_{P} of ˜7/500 nm and a pore volume of V_{Hg,P} of 1.05 cm³/g were used. The exact pore size distribution of the spherical gamma-Al₂O₃ shaped bodies is shown in FIG. 1.

For the sake of completeness and for clarification, it is pointed out here that the notation “mean pore diameter” in this Example 4, and also in the above Example 1, in each case specifies the two mean pore sizes d_{P} of the bimodal pore size distribution, separated by “/”, which have the greatest proportion in the pore volume for the pore volumes in the range of the smaller pore diameter and in the range of the greater pore diameter. dP˜7/500 thus means that the pore volumes in the range of the smaller pore diameter are dominated by pores with a diameter of ˜7 nm and the pore volumes in the range of the greater pore diameter are dominated by pores having a diameter of ˜500 nm. The same applies with regard to Example 1.

### Example 5

### Preparation of an Inventive Catalyst

A catalyst according to Example 4 was prepared, except that the impregnation/drying step was repeated until a catalyst with a calculated uranium loading of 10% by weight was obtained.

### Example 6

### Preparation of an Inventive Catalyst

A catalyst according to Example 4 was prepared, except that the impregnation/drying step was repeated until a catalyst with a calculated uranium loading of 15% by weight was obtained.

### Example 7

### Preparation of an Inventive Catalyst

A catalyst according to Example 4 was prepared, except that the impregnation/drying step was repeated until a catalyst with a calculated uranium loading of 20% by weight was obtained.

### Counterexample 1

### Preparation of a Noninventive Catalyst

A catalyst according to Example 1 was prepared, except that 5 g of spherical gamma-Al₂O₃ shaped bodies (produced by Saint-Gobain) with an average diameter of 1.5 mm, a BET of 260 m²/g, a mean pore diameter dₚ of 10 nm and a pore volume V_{Hg,P} of 0.83 cm³/g were used, and the impregnation/drying step was repeated until a catalyst with a calculated uranium loading of 4.8% by weight was obtained.

### Counterexample 2

### Preparation of a Noninventive Catalyst

A catalyst according to Counterexample 1 was prepared, except that the impregnation/drying step was repeated until a catalyst with a calculated uranium loading of 8.8% by weight was obtained.

### Counterexample 3

### Preparation of a Noninventive Catalyst

A catalyst according to Counterexample 1 was prepared, except that the impregnation/drying step was repeated until a catalyst with a calculated uranium loading of 12.2% by weight was obtained.

### Counterexample 4

### Preparation of a Noninventive Catalyst

A catalyst according to Counterexample 3 was prepared, except that 5 g of spherical gamma-Al₂O₃ shaped bodies (produced by Saint-Gobain) with an average diameter of 1.5 mm, a BET of 200 m²/g, a mean pore diameter dₚ of 9 nm and a pore volume of V_{Hg,P} of 0.55 cm³/g were used.

### Examples 8-14

### Use of the Catalysts from Examples 1-7 for the Heterogeneously Catalytic Oxidation of Hydrogen Chloride to Chlorine at 500° C.

0.2 g of the substances obtained in Examples 1 to 3 was ground by hand in a mortar and introduced as a mixture with 1 g of quartz sand (100-200 μm) into a quartz reaction tube (diameter˜10 mm)

The quartz reaction tube was heated to 500° C. and then operated at this temperature.

A gas mixture of 80 ml/min of hydrogen chloride and 80 ml/min of oxygen was passed through the quartz reaction tube.

After 30 minutes, the product gas stream was passed into a 16% by weight potassium iodide solution for 10 minutes and the iodine formed was back-titrated with a 0.1N thiosulphate solution in order to determine the amount of chlorine introduced.

This was used to calculate the activities, shown in Table 1, of the catalysts according to Examples 1 to 7 at 500° C.

The activity was calculated in all cases by the general formula

$$\frac{{m}_{{Cl}_{2} , determined in titration}}{{m}_{catalyst} \cdot {t}_{measurement time} .}$$

### Counterexamples 5-8

### Use of the Catalysts from Counterexamples 1-4 for the Heterogeneously Catalytic Oxidation of Hydrogen Chloride to Chlorine at 500° C.

The catalytic activity of the catalysts according to Counterexamples 1-4 was measured in accordance with the testing of the inventive catalysts. The resulting activities are also shown in Table 1.

TABLE 1
Results of Examples 8 to 14 for the catalysts according
to Examples 1 to 7 and the results of Counterexamples 5-8
for the catalysts according to counterexamples 1-4

| | Catalyst | Activities at 500° C. |
|---|---|---|
| | according to | [kg_{Cl2}/kg_{cat} · h] |
| Example | | |
| 8 | Example 1 | 3.69 |
| 9 | Example 2 | 6.48 |
| 10 | Example 3 | 7.09 |
| 11 | Example 4 | 4.37 |
| 12 | Example 5 | 6.73 |
| 13 | Example 6 | 7.02 |
| 14 | Example 7 | 7.60 |
| Counterexample | | |
| 5 | Counterexample 1 | 2.45 |
| 6 | Counterexample 2 | 3.48 |
| 7 | Counterexample 3 | 3.53 |
| 8 | Counterexample 4 | 4.39 |

It is evident from Table 1 that the inventive catalysts according to Examples 1-7 have a significantly higher activity for the heterogeneously catalytic oxidation of hydrogen chloride to chlorine than the catalysts according to Counterexamples 1-4 (as obtained similarly from the prior art, for instance according to PCT/EP2008/005183).

1. Catalyst for heterogeneously catalytic oxidation of hydrogen chloride to chlorine, comprising at least one catalytically active component composed of a uranium compound and a support material composed of aluminium oxide, wherein the catalyst has a bimodal pore size distribution.

2. Catalyst according to claim 1, wherein the uranium compound is a uranium oxide with a stoichiometric composition of UO_{2.1} to UO_{2.9}.

3. Catalyst according to claim 1, wherein the uranium compound is a uranate of at least one alkali metal and/or alkaline earth metal.

4. Catalyst according to claim 1, wherein the bimodal pore size distribution has a first range of smaller pore diameter from 1 to 20 nm and a second range of greater pore diameter from 100 to 5000 nm.

5. Catalyst according to claim 1, wherein the bimodal pore size distribution has a proportion of pore volumes in the range of the smaller pore diameter of 40% to 60% and a proportion of pore volumes in the range of the greater pore diameter of 60% to 40%, the sum of the proportions being less than or equal to 100%.

6. Catalyst according to claim 1, wherein the proportion of the uranium compound in the overall catalyst is in the range from 1 to 40% by weight.

7. Process for preparing a catalyst for the heterogeneously catalytic oxidation of hydrogen chloride to chlorine, comprising at least the steps of:
a) providing a solution A comprising a uranium salt in a solvent,
b) coating particles of aluminium oxide with solution A to obtain coated particles B,
c) drying the coated particles B, and
d) optionally shaping shaped bodies from the coated particles B obtained from one of steps b) and c).

8. Process according to claim 7, wherein the uranium salt is selected from the group consisting of uranyl acetate UO₂Ac₂, uranyl acetate dihydrate UO₂Ac₂.2H₂O, uranyl oxide nitrate UO₂(NO₃)₂, and uranyl oxide nitrate hexahydrate UO₂(NO₃)₂.6H₂O.

9. Process according to claim 8 wherein shaping according to step d) is performed, in which the particles B from step c) are shaped to shaped bodies by adding a binder and by subsequent drying, in the course of which drying step the particles B are pressed into a negative mould of the desired shaped body.

10. Process according claim 7, wherein the coated particles B from step b) are sent to drying under elevated pressure relative to atmospheric pressure, this pressure being obtained by compressing a negative mould of the desired shaped body around the particles B with which the negative mould has been filled.

11. Process according to claim 7, wherein the drying is performed at temperatures of 500° C. to 1500° C.

12. Process according to claim 7, wherein the drying is performed in a plurality of stages, a first stage involving preliminary drying at room temperature to 250° C. and a second stage further drying at temperatures of 500° C. to 1500° C.

13. Process for preparing chlorine, wherein hydrogen chloride is oxidized with oxygen to chlorine in a reaction zone in the presence of a catalyst with bimodal pore size distribution comprising at least one catalytically active component composed of a uranium compound and a support material composed of aluminium oxide.

14. Method of using a catalyst according to claim 1 as a catalyst for oxidizing hydrogen chloride to chlorine.
